(19) United States
(12) Patent Application Publication
(10) Pub. No.: US 2013/0346267 A1
(43) Pub. Date: Dec. 26, 2013

(54) ENTERPRISE PAYROLL APPLICATION CONFIGURATION AND PROVISIONING

(71) Applicant: EPI-USE Systems, Ltd., Douglas (IM)

(72) Inventors: Johann Heinrich Portwig, George (ZA); Walter Jacobus van den Hever, Mooikloof (ZA); Nicolaus C. Thirion, Scottsdale, AZ (US)

(73) Assignee: EPI-USE Systems, Ltd., Douglas (IM)

(21) Appl. No.: 13/893,982

(22) Filed: May 14, 2013

Related U.S. Application Data
(60) Provisional application No. 61/663,567, filed on Jun. 23, 2012.

(51) Int. Cl. G06Q 40/00

(52) U.S. Cl. CPC G06Q 40/105
USPC 705/32

(57) ABSTRACT

Technologies are described herein for rapidly implementing and deploying enterprise payroll systems. A standard enterprise payroll system is deployed and a pre-configured payroll template is loaded into the standard enterprise payroll system to form a pre-configured standard payroll system. A configuration set containing implementation-specific configuration values is generated based on user provided configuration input and business rule configuration logic from a pre-configured database corresponding to pre-configured payroll template. The generated configuration set is loaded into the pre-configured standard payroll system to create an instantiated enterprise payroll system.

### CROSS-REFERENCE TO RELATED APPLICATIONS

This application claims the benefit of U.S. Provisional Patent Application No. 61/663,567 filed on Jun. 23, 2012, entitled “Systems and Methods for Providing Enterprise Payroll Application Configuration and Provisioning,” which is expressly incorporated herein by reference in its entirety.

### BACKGROUND

A traditional implementation and deployment of enterprise payroll applications may take 6 to 18 months and may require experienced, trained and expensive enterprise application consultants. The traditional implementation process generally follows a methodology characterized by the following phases with various check-points and controls:
1. Project planning and preparation—during this phase, the project charter is drafted, specific milestones are agreed and implementation constraints are identified. This phase is also used to set-up the project office.
2. Business requirements analysis and solution design—process/functionality owners and key users from each business unit are brought together to document requirements including existing current solution gaps. The final consolidated requirements document is the basis for the detailed functional specification for the new system.
3. Implementation—the system configuration takes place in accordance with the detailed functional specification. Development of interfaces, reports and data migration also takes place. Training documentation is developed.
4. Data conversion, testing and training—data take-on, parallel payroll runs and user acceptance testing takes place. A number of payroll parallel runs are executed to confirm the correctness of calculations. Training activities are performed.
5. Go-live and productive operation—The system is switched over for productive use.

It is with respect to these and other considerations that the disclosure made herein is presented.

### BRIEF SUMMARY

The present disclosure relates to technologies for rapidly implementing and deploying enterprise payroll systems. According to some embodiments, a method comprises loading a pre-configured payroll template into a deployed standard enterprise payroll system to form a pre-configured standard payroll system. A configuration set containing implementation-specific configuration values is generated based on user provided configuration input and business rule configuration logic from a pre-configured database corresponding to pre-configured payroll template. The generated configuration set is then loaded into the pre-configured standard payroll system to create an instantiated enterprise payroll system.

According to further embodiments, a computer-readable storage medium comprises processor-executable instructions that cause a processor to access a pre-configured database comprising business rule configuration logic for managing at least one implementation-specific configuration value of an enterprise payroll system and generate a set of business-language questions based on the business rule configuration logic. The set of questions is presented to a user through a user interface and the user uses the user interface to provide configuration input comprising answers to the set of questions. The processor generates a configuration set based on the provided configuration input and the business rule configuration logic, and the configuration set is loaded into a pre-configured standard payroll system to create an instantiated enterprise payroll system.

According to further embodiments, a system comprises a configuration assistant application configured to access a pre-configured database comprising business rule configuration logic for managing at least one implementation-specific configuration value of an enterprise payroll system and generate a set of business-language questions based on the business rule configuration logic. The configuration assistant application presents the set of questions to a user through a user interface and the user uses the user interface to provide configuration input comprising answers to the set of questions. The configuration assistant application generates a configuration set based on the provided configuration input and the business rule configuration logic, and the configuration set is loaded into a pre-configured standard payroll system to create an instantiated enterprise payroll system.

These and other features and aspects of the various embodiments will become apparent upon reading the following Detailed Description and reviewing the accompanying drawings.

### BRIEF DESCRIPTION OF THE DRAWINGS

In the following Detailed Description, references are made to the accompanying drawings that form a part hereof, and that show, by way of illustration, specific embodiments or examples. The drawings herein are not drawn to scale. Like numerals represent like elements throughout the several figures.

FIG. 1 is a block diagram showing an illustrative virtual architecture of an instantiated enterprise payroll system, according to embodiments described herein.

FIG. 2 is a system diagram showing illustrative deployment scenarios for an instantiated enterprise payroll system, according to embodiments described herein.

FIG. 3 is a block diagram showing an illustrative environment for rapidly implementing and deploying enterprise payroll applications, including hardware and software components and data structures, according to embodiments described herein.

FIGS. 4A-4D are screen diagrams showing an illustrative user interface for collecting user configuration input, according to embodiments described herein.

FIGS. 5-6 are flow diagrams showing routines for rapidly implementing and deploying enterprise payroll systems, according to embodiments described herein.

FIG. 7 is a block diagram showing aspects of a configuration commander tool utilized for rapidly implementing and deploying enterprise payroll systems, according to embodiments described herein.

FIG. 8 is a computer architecture diagram showing an illustrative computer hardware architecture for computing devices described in embodiments presented herein.

### DETAILED DESCRIPTION

The following detailed description is directed to technologies for rapidly implementing and deploying enterprise payroll systems. Utilizing the technologies described herein, a standard enterprise payroll application used in conjunction with a payroll template and configuration tools may allow for automated enterprise payroll application configuration and provisioning. By providing a unique configuration utility combined with pre-configured templates, the systems and methods described herein may reduce the implementation and deployment times to one to two weeks rather than months. The need for enterprise application consultants may also be reduced significantly and the solution deployment time may be more aligned with client expectations around new technology, such as cloud-based solutions.

The reduction in time, cost and effort may stem from the use of a few pre-configured payroll templates for use in all implementations. The pre-configured payroll templates can be updated and improved continuously, while configuration sets containing implementation-specific rules and configurations may be stored externally in a system release-independent manner, minimizing the effect of changes to the standard enterprise payroll system due to upgrades and new legal requirements. Use of the pre-configured payroll templates may provide comprehensive solutions that address most of the payroll needs in the market. By not allowing for very specific and unique situations, complexity may be greatly reduced. The pre-configured payroll templates consisting of standard payroll processes and configurations may be built based on the experience of many enterprise consultants and may cover most of the scenarios that the consultants have come across in the area of payroll management.

In addition, consultant involvement may be limited or eliminated during the implementation as business users may utilize a configuration assistant for configuration and generation of implementation-specific configuration sets. The configuration assistant may allow for the rapid change of parameters in the enterprise payroll system and the selected pre-configured payroll template, thereby allowing the enterprise payroll system to be configured in a few days in one system environment which caters to a plurality of clients. The business analysis and solution design phase may be substantially reduced as enterprise payroll systems implemented using the techniques and tools described herein may work “out-of-the-box” and clients may select and configure the components and functionality they want to activate through the configuration assistant.

Client-level testing and parallel runs become only data confirmation steps as the pre-configured payroll templates utilized for infrastructure configuration are certified and tested before release to clients. Further, the systems and methods described herein may be capable of utilizing a cloud-based delivery model to provide support for multiple clients. The configured enterprise payroll system may be deployed in the “cloud” with connections to the existing on-premise client systems.

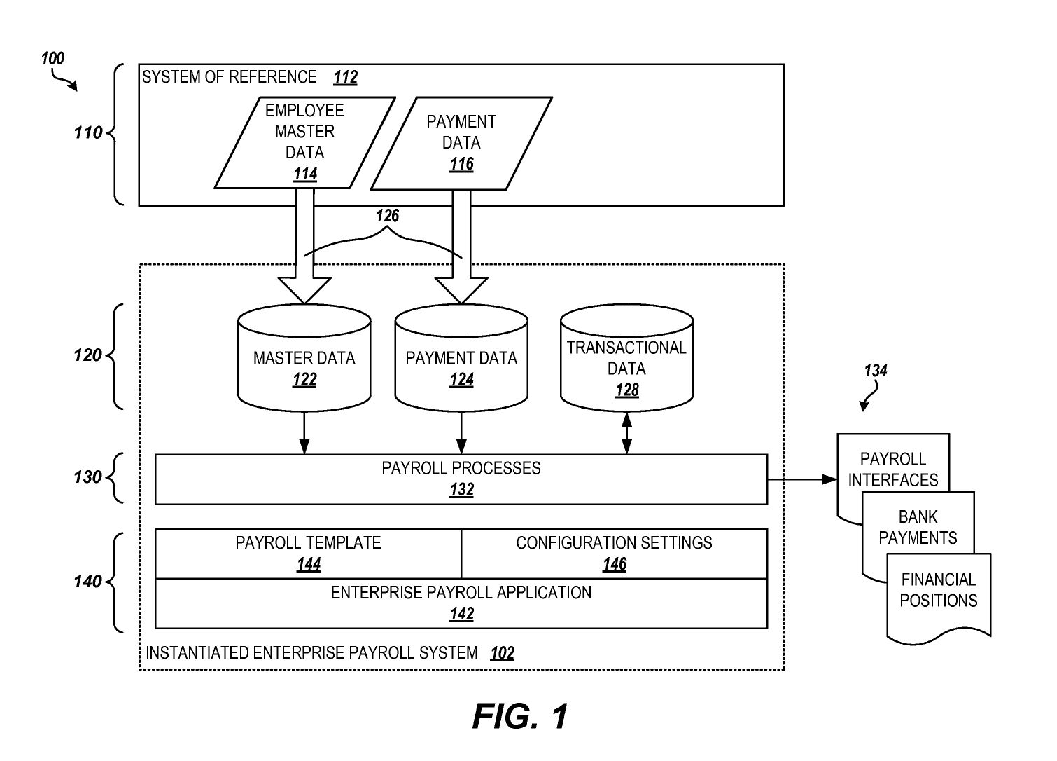

FIG. 1 provides an illustrative virtual architecture 100 of an instantiated enterprise payroll system 102, according to embodiments. The virtual architecture 100 of the instantiated enterprise payroll system 102 may comprise a number of layers. A system of reference layer 110 may include a system of reference 112. The system of reference 112 may be external to the instantiated enterprise payroll system 102 and may be the entry point for any employee and payment related data. According to some embodiments, the system of reference 112 may include employee master data 114 and payment data 116. Employee master data 114 may include employee indicative data such as name, address, workplace, social security number, bank details, salary details and the like.

Payment data 116 may include earnings and deductions that influence the payroll calculations, such as working time, bonuses, overtime, statutory benefits deductions and the like. Payment data 116 may also include data such as tax categories, benefit options and the like. The system of reference 112 may be the control environment where the payroll execution is controlled and any changes are made to other layers of the instantiated enterprise payroll system 102. The system of reference 112 may comprise multiple applications running on a number of computer systems and providing employee master data 114, payment data 116 or a combination thereof.

The instantiated enterprise payroll system 102 may comprise a data layer 120 including master data 122 and payment data 124. The master data 122 and payment data 124 may be replicated or otherwise transferred from the corresponding employee master data 114 and payment data 116 provided by the system of reference 112. In some embodiments, data integration 126 may be implemented to transfer the employee master data 114 and payment data 116 from the system of reference 112 into the data layers 120 of the instantiated enterprise payroll system 102. The data integration 126 may represent a bi-directional data exchange between the system of reference 112 and the instantiated enterprise payroll system 102 and may utilize a common data definition based upon industry standards.

The employee master data 114 and payment data 116 from the system of reference 112 may be transformed into enterprise data structures utilized by the instantiated enterprise payroll system 102 for storage in the master data 122 and payment data 124 in the instantiated enterprise payroll system 102. In some embodiments, the data representation may change for specific fields. For example, the data representation of gender may be “M” and “F” in the system of reference 112 and “1” and “2” in the instantiated enterprise payroll system 102. However, the semantics of the fields may remain the same between the system of reference 112 and the instantiated enterprise payroll system 102.

The data layer 120 may further include transactional data 128. According to embodiments, during the payroll process, the master data 122 and payment data 124 are used to produce the payroll transactional data 128. The transactional data 128 may be the end result of the payroll process and may contain data such as payments to employees, earnings such as salary, overtime and various allowances, deductions such as taxes and social insurance, benefits and the like. It will be appreciated that the master data 122, payment data 124 and transactional data 128 in the data layer 120 represent the subset of the data in the system of reference layer 110 necessary for executing the instantiated payroll in the format and tables required by a processing layer 130 and an application layer 140 of the instantiated enterprise payroll system 102, both of which are described below.

The processing layer 130 of the instantiated enterprise payroll system 102 may comprise various types of payroll processes 132 available in the payroll system. Different payroll processes 132 may be required at specific points in time, each of which uses and affects the underlying data in different ways. For example, the payroll processes 132 may include an on-cycle payroll process that defines a regular monthly or bi-weekly payroll process and an annual process that defines the way in which tax returns for tax filing purposes are produced. The payroll processes 132 may further include both periodic and non-periodic processes. For example, after every payroll period, pay statements may be produced and payments to employees and third parties are made. Annually or over other periodic intervals, tax returns may be produced and data may be sent to the revenue authorities. Irregular payments may be made in an off-cycle process, for example, when an employee receives a special bonus and it is paid immediately.

The application layer 140 of the instantiated enterprise payroll system 102 may comprise an enterprise payroll application 142, such as the SAP® BUSINESS SUITE application from SAP AG of Walldorf, Germany. The application layer may further comprise a payroll template 144 and configuration settings 146. The payroll template 144 may define a set of payroll processes 132 that provides the base payroll functionality to the enterprise payroll application 142. The payroll template 144 and configuration settings 146 together may further define business rules that determine how external data is represented in the instantiated enterprise payroll system 102. This may include the way in which the employee's workplace, employment details, compensation and benefits are represented, e.g., as a four character field that represents a certain organization location. The business rules may also determine the payroll processing rules, e.g., how to perform pro-rata calculations when an employee joins or resigns in the middle of a payroll period.

The payroll template 144 and/or configuration settings 146 may further define a number of external interfaces 134 to external systems, such as benefits providers, financial systems and bank interfaces for employee payments, as further shown in FIG. 1. As will be described in more detail below, the enterprise payroll application 142, the payroll template 144 and the configuration settings 146 may together provide base payroll functionality in the instantiated enterprise payroll system 102. The configuration settings 146 may further refine the business rules from the payroll template 144 to include implementation-specific details for payroll processing in the instantiated enterprise payroll system 102.

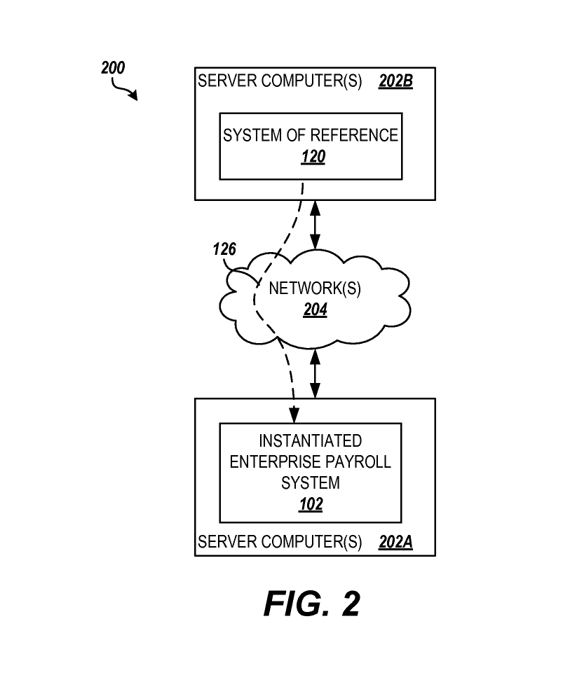

FIG. 2 and the following description are intended to provide a general description of a suitable computing environment 200 in which the systems and applications described herein may be implemented. According to some embodiments, the instantiated enterprise payroll system 102 may be implemented on one or more server computers 202A. The server computer(s) 202A may comprise application servers, Web servers, database servers, file servers, workstations, network appliances, personal computers (“PCs”) or any other computing devices known in the art. The instantiated enterprise payroll system 102 may comprise a combination of application modules, components, data structures and the like executing in or stored on the server computer(s) 202A. The application modules, components and data structures may be implemented in software, hardware or a combination of the two.

Similarly, the system of reference 112 may be implemented on one or more server computers 202B and may comprise a combination of application modules, components, data structures and the like executing in or stored on the server computer(s). The server computer(s) 202A on which the instantiated enterprise payroll system 102 is implemented may be connected to the server computer(s) 202B on which the system of reference 112 is implemented by one or more networks 204. The network(s) may comprise local-area networks (“LANs”), wide-area networks (“WANs”), the Internet or any other networking topology known in the art that connects the server computer(s) 202A and 202B. The network(s) 204 may further interconnect the various server computer(s) 202A or 202B. The data integration 126 described above in regard to FIG. 1 between the system of reference 112 and the instantiated enterprise payroll system 102 may be implemented over the network(s) 204. The data integration 126 may be implemented utilizing industry standard communication services, taking into account security and data privacy requirements.

The instantiated enterprise payroll system 102 and/or system of reference 112 may be deployed in various scenarios. For example, the instantiated enterprise payroll system 102 may be deployed in a cloud-hosted environment and integrated with an on-premise system of reference 112. Payroll users may access the on-premise system of reference 112 to capture employee master data 114 and payment data 116 and/or to execute payroll processes 132 in the instantiated enterprise payroll system 102. In another example, the system of reference 112 may also be deployed in the cloud. In a further example, the instantiated enterprise payroll system 102 may be deployed in the same on-premise environment as the client's system of reference 112.

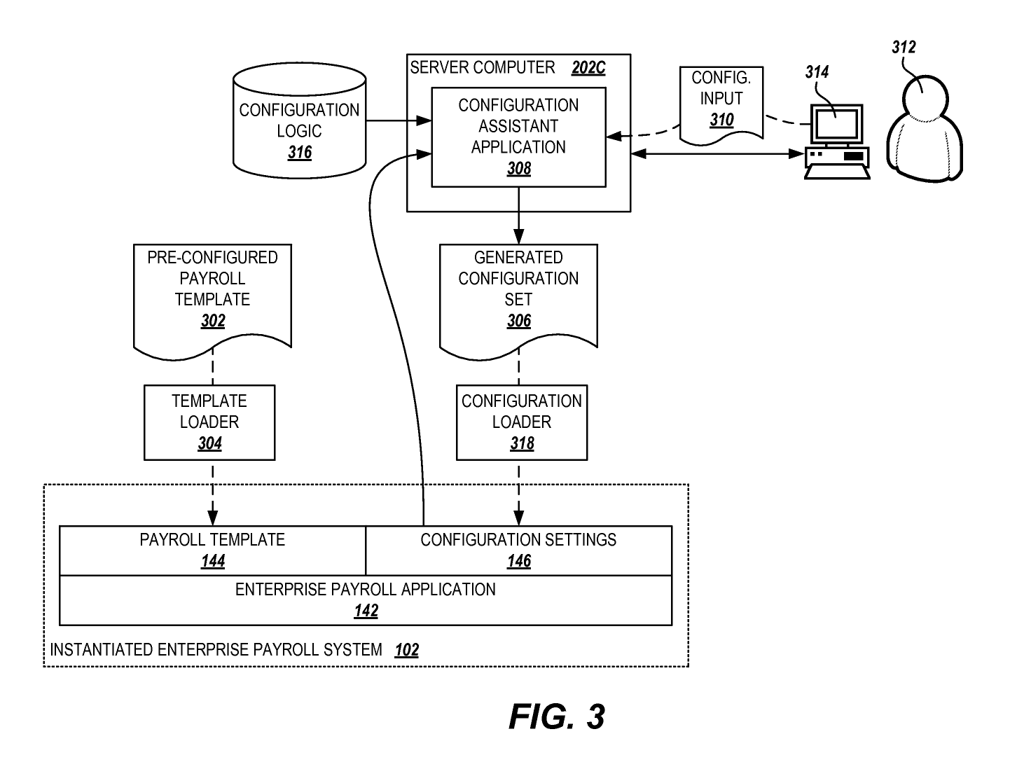

FIG. 3 shows further details of the creation of an instantiated enterprise payroll system 102, including several software components and data structures for implementing and deploying the instantiated enterprise payroll system 102, according to embodiments provided herein. According to embodiments, an instantiated enterprise payroll system 102 refers to a payroll system where payroll functionality is supported via a base set of standard payroll processes, and where complexity is reduced by covering the most common variations through one or more pre-configured payroll templates, such as pre-configured payroll template 302. The pre-configured payroll template 302 may define the set of payroll processes 132 that provide the standard functionality to the enterprise payroll application 142. The pre-configured payroll template 302 may further define the business rules, data structures and semantics, payroll processing rules, external interfaces 134 and the like required to provide the standard payroll functionality, as described above in regard to FIG. 1.

The pre-configured payroll template 302 may extend the standard configuration, programs and transactions of the enterprise payroll application 142 to cover a high percentage of the business requirements and all of the legal requirements of business organizations implementing an instantiated enterprise payroll system 102. It will be appreciated that, while the pre-configured payroll template 302 cannot cover every combination and permutation of what is possible to implement and configure the enterprise payroll application 142, the selected pre-configured payroll template 302 may provide the most extensive coverage of a particular business organization's requirements. Additionally, some configuration parameters, such as organization names, plants, earnings codes and the like, will be implementation specific and cannot be captured generically in the pre-configured payroll template 302.

According to some embodiments, the content of the pre-configured payroll template 302 is based on patterns, similar to design patterns as used in software development. The pre-configured payroll template 302 may consist of a number of pre-defined patterns. A pattern may represent a valid set of payroll application configuration objects or configuration table entries that, if provided with implementation-specific configuration values from the generated configuration set 306 described below, constitute a valid configuration of a business rule, process or object in the enterprise payroll application 142. In the case of SAP, each pattern may represent a valid set of configuration tables, features, rules and schemas. Multiple patterns may be required to implement a functional component in the enterprise payroll application 142. An example may be a shift allowance pattern. The shift allowance pattern may configure the rule for when the shift allowance should be paid and what the rate should be. The actual values of the implementation-specific configuration parameters for this pattern may be supplied by a user, such as the earnings code, shift allowance percentage, text description and the like. Once the user-supplied parameters are combined with the pattern and uploaded to the enterprise payroll application 142, the rule is available for use by the payroll processes 132.

In some embodiments, a pre-configured payroll template 302 may include the configuration (instantiation through parameters) of a number of components:
1. Organization Structure
2. Personnel Structure
3. Employee Structure
4. Payroll Structure
5. Earning and Deduction Structure
6. Pay-scale Structure
7. Holiday Calendars
8. Work Patterns
9. Absences and Attendances
10. Gross Pay Calculation
11. Net Pay Calculation
12. Banking
13. Reporting
14. Financial Settlement
   In addition to these there may be country-specific or industry-specific processes that must be configured. For example, tax and social insurances are generally specific to each country. It will be appreciated that the pre-configured payroll template 302 may include both shared concepts across countries as well as country-specific configurations. For example, the personnel structure may be used to model an organization's plants or locations, but depending on the country the template patterns may require different organization tax and social insurance numbers, offices, calendars, and the like.

In some embodiments, there may be separate pre-configured payroll templates 302 for different countries and/or different industries or industry categories. In further embodiments, the pre-configured payroll template 302 may contain a “superset” of the payroll country, legal and business requirements supported by the application. The pre-configured payroll template 302 may define and implement the available payroll options for each supported country, such as earnings and deductions codes. It will be appreciate that the pre-configured payroll template 302 may comprise other components beyond the patterns described above. The pre-configured payroll template 302 may further be included in regression-testing cycles, ensuring that certain assertions may be made about the correctness of the different clients. Removing the requirements to regression test each individual client implementation greatly reduces validation effort required to ensure that future upgrades and changes to the standard enterprise payroll application are all handled correctly.

According to embodiments, a pre-configured standard payroll system may be created by deploying the enterprise payroll application 142 to the target server computer(s) 202A and loading a pre-configured payroll template 302 into the deployed application. The pre-configured standard payroll system may further include standard configuration settings 146 supplied by or associated with the pre-configured payroll template 302. The pre-configured payroll template 302 may be loaded into the enterprise payroll application 142 utilizing a template loader 304. The template loader 304 may represent a function or utility of the deployed enterprise payroll application 142, or the template loader may comprise a third-party utility used in the deployment of the enterprise payroll application.

The instantiated enterprise payroll system 102 may be created by loading a generated configuration set 306 containing implementation-specific configuration values and parameters, business and processing rules and the like into the pre-configured standard payroll system. The generated configuration set 306 may be generated by a configuration assistant application 308. The configuration assistant application 308 may comprise a knowledge base, mapping implementation-specific requirements to the most appropriate system settings as available within the enterprise payroll system data and process models. In some embodiments, the configuration assistant application 308 may be implemented on one or more server computer(s) 202C, such as a Web server, and may collect configuration input 310 from a user 312, through a user interface of client computing device 314, in order to generate the generated configuration set 306.

In some embodiments, the generated configuration set 306 may comprise a spreadsheet file, a CSV file, an XML file or any other data structure known in the art and may be stored on any suitable data storage device or devices. In other embodiments, the generated configuration set 306 may comprise data generated by the configuration assistant application 308 that is uploaded directly to the instantiated enterprise payroll system 102, via a Web service or other application programming interface (“API”), for example.

In further embodiments, the configuration assistant application 308 may access a pre-configured database of configuration logic 316. The pre-configured database of configuration logic 316 may support a number of pre-configured payroll templates 302 used to create the pre-configured standard payroll system. Alternatively or additionally, there may be a separate pre-configured database of configuration logic 316 corresponding to each of a number of pre-configured payroll templates 302 available. In some embodiments, the pre-configured database of configuration logic 316 may comprise configuration rules to manage the associated implementation-specific configuration values that are required for the patterns and other configurations defined by the pre-configured payroll template 302. The configuration rules may describe which patterns in the template should be instantiated to implement the business requirements of the organization.

The pre-configured database of configuration logic 316 may include scope rules that describe the scope of functionality in the instantiated enterprise payroll system 102 and the dependency between functional components. Some scope rules may be country-independent while others may be country-dependent based on a specific country associated with the pre-configured payroll template 302 template and the patterns contained within. Scope rules may be defined by using business terms that have meaning to business users in the context of payroll functionality. These may not be the same terms used by the enterprise payroll application. For example, scope rules may comprise a hierarchical representation of payroll functional components, where each leaf node represents a template pattern, such as:

Payroll consists of

Gross Calculation (Required)
Net Calculation (Required)
...

Gross Calculation consists of

Planned Remuneration (Required)

Advised values (Optional)
Pay Scale selection (Optional)

Pay Scale is assigned to a Personnel Sub Area

...

Actual Time Worked (Optional)

...

...

Net Calculation consists of

Voluntary Deductions (Required)

Canteen Fees (Optional)

Canteen Fees consist of a Deduction Code and an amount

Statutory Deductions (Required)

Tax (Required)

Tax requires a Tax Company

These scope rules may determine what business objects must be defined and what configuration setting values are required to be collected based on the selection of required and optional functional components. Further, the scope rules may ensure the integrity of the full list of functional components for which configuration settings will be collected for configuration of the enterprise payroll application 142.

The pre-configured database of configuration logic 316 may further comprise business objects and associated rules, also referred to as “business terms.” The business objects may represent real world entities that are known to business users in the context of the payroll application. The associated rules may answer the question “if we use the functionality defined by the scope rules, what business objects or terms do we need?” There may be a pattern in the pre-configured payroll template 302 to configure an instance of each type of business object. The pattern may define configuration settings and parameters for which implementation-specific values are required, such as company name, address, tax number(s) and the like. The business objects and associated rules may further define rules to gather this information from the user 312 through the configuration assistant application 308, as will be described below.

The pre-configured database of configuration logic 316 may further comprise structure rules. The structure rules may answer the question “if the business object is mapped to a template pattern, which additional relationships and attributes are required?” The structure rules may be equivalent to a database entity-relationship (“ER”) diagram that defines how the business objects are related to each other and the specific attributes of each. The attributes and relationships may be determined by the parameters required for each pattern associated with the business object. Some of these may be supplied by business users as new values while others may reference existing objects. For instance, a pattern in SAP to instantiate the personnel sub area pattern may require a parameter that is a personnel area.

The pre-configured database of configuration logic 316 may further comprise constraint rules. The constraint rules may allow the configuration of the enterprise payroll application 142 to implement a business rule such as “if A, B and C are true then apply a specific rule or perform a specific action.” The constraint rules may be represented in various formats. For example, in SAP a common format for a constraint rule is called a grouping. A grouping may be used, for example, to indicate that employees from all plants on the West Coast of the United States are to be paid the same or are to receive the same benefits. Constraint rules may be closely tied to and dependent upon the pre-configured payroll template 302. If a constraint in a constraint rule of a given template is violated, the result may be to create additional (split or merge) business objects to allow the business requirement to be implemented within the constraints of the given pre-configured payroll template.

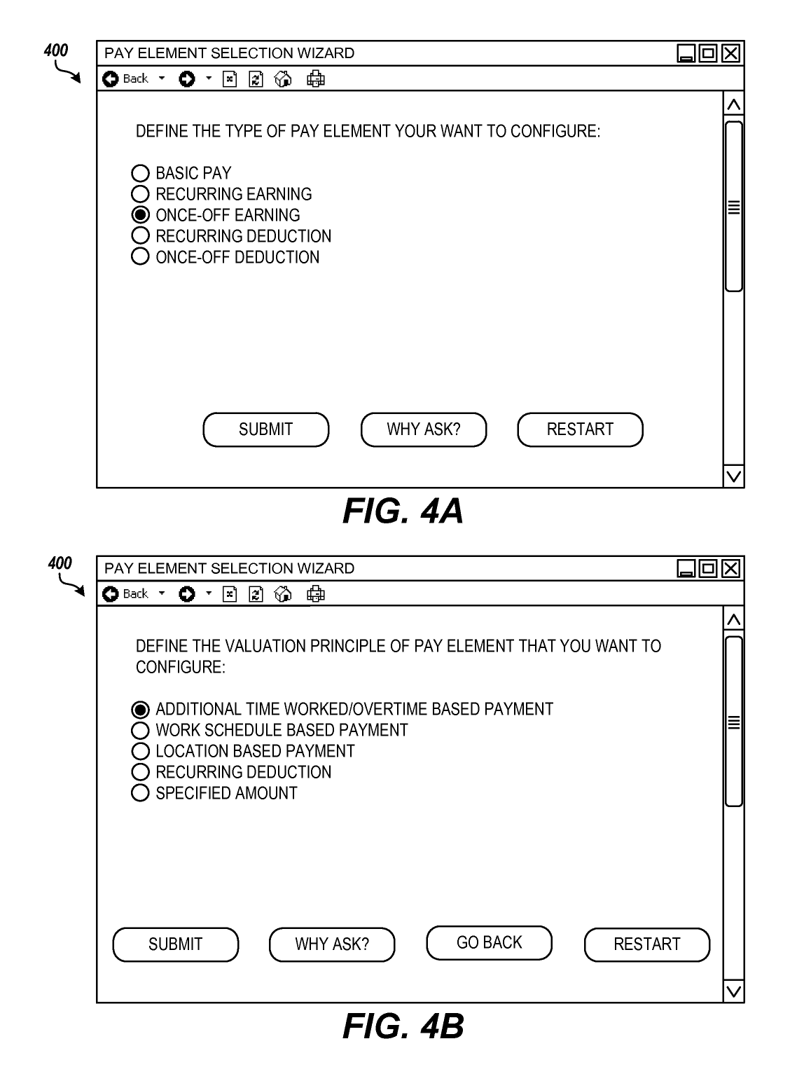

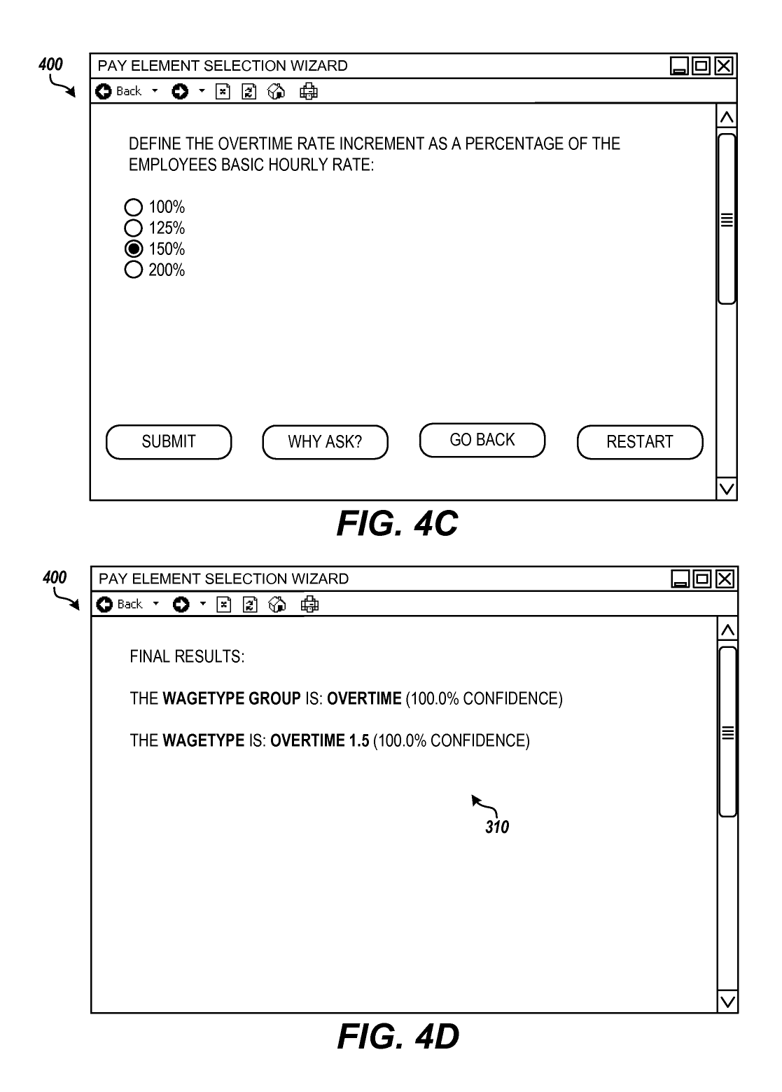

According to embodiments, the configuration assistant application 308 may utilize the configuration rules defined in the pre-configured database of configuration logic 316 and/or the existing configuration settings 146 from the pre-configured standard payroll system or instantiated enterprise payroll system 102 to generate a set of strategic questions and display the questions to the user 312 through a user interface on a client computing device 314, such as a PC as shown in FIG. 3. The user 312 may then utilize the user interface of the client computing device 314 to provide the configuration input 310 comprising answers to the questions to the configuration assistant application 308. FIGS. 4A-4D provide one example of a user interface 400 displayed to the user 312 by the configuration assistant application 308, according to some embodiments.

The configuration assistant application 308 may then use the provided configuration input 310 and the configuration logic 316 to generate the generated configuration set 306 containing the appropriate implementation-specific configuration settings. For example, the configuration assistant application 308 may display the following questions and the like to the user 312 to determine the workplace structure:
Is your organization operational in multiple locations?
If so, provide the list of locations?
Provide a list of all types of activities that are performed in your organization (e.g., marketing, manufacturing, sales, etc.).
Associate each activity with at least one location.
Are there special payment related conditions associated with your locations?
Are there special payment related conditions associated with your business activities?

Based on the answers to these questions, new configuration rules and new questions may come into scope. The scope rules in the in the pre-configured database of configuration logic 316 may ensure the constancy of the questions, configuration settings and business objects or terms configured over the entire scope of functionality. The configuration assistant application 308 may utilize the answers to these questions provided by the user 312 in the configuration input 310 and the configuration rules in the pre-configured database of configuration logic 316 to generate the generated configuration set 306 containing the configuration values for the payroll system parameters and options that reflect the user's specified answers to the questions. Continuing from the previous example, the generated configuration set 306 may contain the following configuration values and the like:

| | | | |
|---|---|---|---|
| 0001 | Head-office | Administration | Standard conditions |
| 0001 | Head-office | Marketing | Performance bonuses |
| 0002 | Site 1 | Manufacturing | Shift allowances |
| 0003 | Site 2 | Quality control | Standard conditions |

The generated configuration set 306 may then be loaded into the configuration settings 146 of the pre-configured standard payroll system to generate the instantiated enterprise payroll system 102 ready for loading of the implementation-specific master data 122 and payment data 124. The generated configuration set 306 may be loaded into the configuration settings 146 by a configuration loader 318. The configuration loader 318 may represent a function or utility of the deployed enterprise payroll application 142, or the configuration loader may comprise a third-party utility used in the deployment of the enterprise payroll application. During the loading of the generated configuration set 306 by the configuration loader 318, the supplied configuration values may be used to create instances of the template patterns. The template patterns may ensure that the pieces of configuration are valid and correct as far as the constraints defined by the enterprise payroll application 142. It will be appreciated that by using the pre-configured payroll template 302 as input and then performing the client specific configuration based on the business requirements of the user 312 with the configuration assistant application 308, the implementation cycle of the instantiated enterprise payroll system 302 may be reduced from months to days.

In further embodiments, the payroll systems of a plurality of organizations may be hosted on the same server computer(s) 202A and same enterprise payroll application installation. The instantiated enterprise payroll system 102 may be used to create a unique and separate payroll system for each organization so that all the data and configuration settings 146 are kept separate from other organizations. In some embodiments, all organizations with payroll systems hosted with the instantiated enterprise payroll system 102 may share the same payroll template 144 with the implementation-specific configuration values for each represented by separate, limited configuration settings 146.

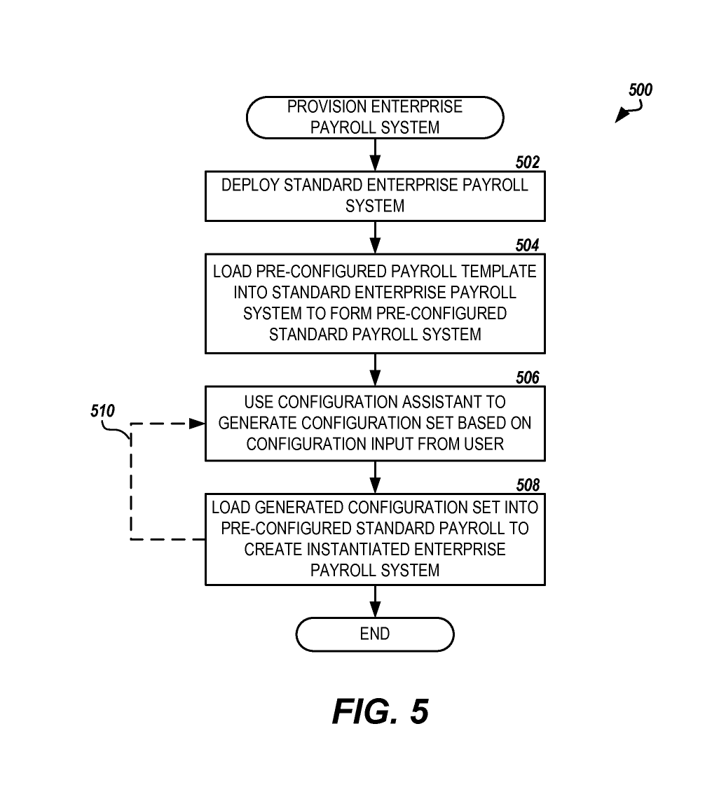

FIG. 5 illustrates one routine 500 for rapidly implementing and deploying enterprise payroll systems, according to some embodiments. The routine 500 may be utilized during the implementation and deployment of the instantiated enterprise payroll system 102, for example. The routine 500 may be performed by various tools, utilities and other software applications utilized in the implementation and deployment of the instantiated enterprise payroll system 102. For example, the routine 500 may be partially implemented by the template loader 304, the configuration assistant application 308 and the configuration loader 318 described above in regard to FIG. 3 executing on one or more server computers, such as server computer(s) 202C. The routine 500 begins at step 502, where a standard enterprise payroll system is deployed. According to some embodiments, this may comprise installing an enterprise payroll application 142 on target server computer(s) 202A with standard/default installation and configuration settings 146. In the case of an SAP BUSINESS SUITE payroll application installation, this may be referred to as the “installation master copy” and may comprise a standard SAP installation with a specific release, enhancement pack and support stack. The standard enterprise payroll system may be installed according to published enterprise system installation guidelines and standards.

From step 502, the routine 500 proceeds to step 504, where the pre-configured payroll template 302 is loaded into the standard enterprise payroll system deployed in step 502. As discussed above in regard to FIG. 3, the pre-configured payroll template 302 may define the set of standard payroll processes 132 that provide the base functionality to the enterprise payroll application 142 as well as the business rules, data structures and semantics, payroll processing rules, external interfaces 134 and the like required to provide the base payroll functionality. The pre-configured payroll template 302 may further comprise standard configuration settings 146 that support the base payroll functionality. In the case of an SAP BUSINESS SUITE payroll application installation, the pre-configured payroll template 302 may be referred to as the “transport” and may contain the configuration settings 146 that reflect the latest version of the template. In some embodiments, the pre-configured payroll template 302 may be pre-certified as functionally correct and ready to deploy.

As further discussed above in regard to FIG. 3, the pre-configured payroll template 302 may be loaded into the standard enterprise payroll system using the template loader 304 to form the pre-configured standard payroll system. The pre-configured standard payroll system may also be referred to as the “pre-configured client” in SAP BUSINESS SUITE payroll application installations and may contain the standard SAP configuration objects with specific pre-configured settings as well as additional configuration objects. For example, earning and deduction codes such as overtime at 150%, basic salary and canteen allowances may represent pre-configured objects. In addition, further processing rules to enable certain calculations, such as overtime at 150% depending on the employee's hourly pay rate multiplied by the number of hours, may also be included in the pre-configured client.

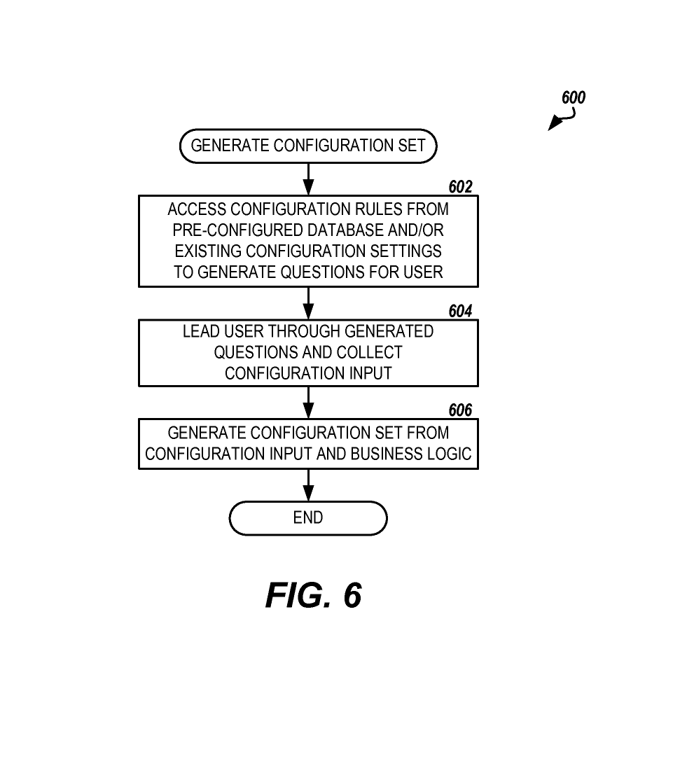

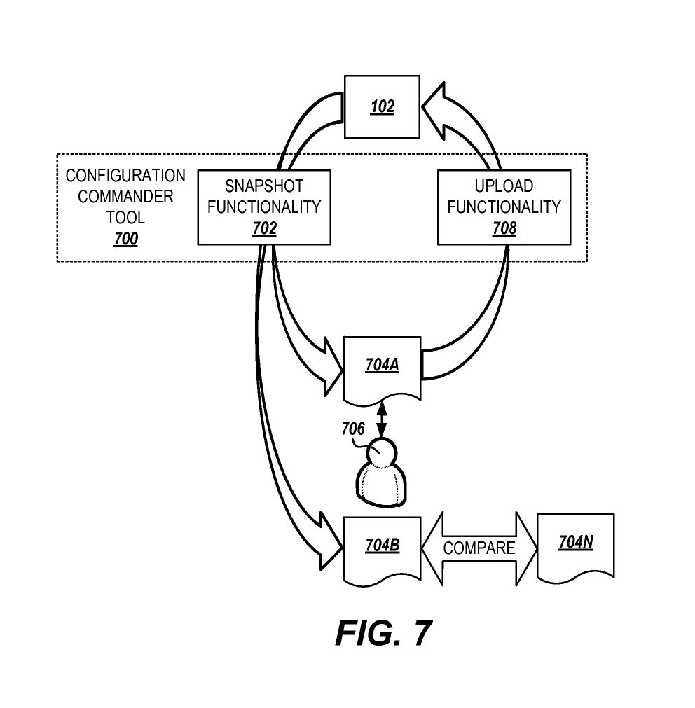

The routine 500 proceeds from step 504 to step 506, where the generated configuration set 306 containing implementation-specific configuration parameters and values is generated from configuration input 310 received from the user 312, as described in more detail herein in regard to FIGS. 3 and 6. From step 506, the routine 500 proceeds to step 508, where the generated configuration set 306 is loaded into the pre-configured standard payroll system to create the fully configured instantiated enterprise payroll system 102. The generated configuration set 306 may be loaded into the pre-configured standard payroll system by utilizing a configuration loader 318. The configuration loader 318 may read the generated configuration set 306, and through a process of applying mapping and transformation rules, create equivalent configuration settings 146 that are uploaded to the pre-configured standard payroll system. The mapping, transformation and upload mechanism may be specific to the target enterprise payroll application 142. For example, in the case of an SAP BUSINESS SUITE payroll application installation, a specialized configuration loader 318, also referred to herein as the “configuration commander tool,” may be used to read the generated configuration set 306 comprising an external file and to load the implementation-specific configuration parameters and values contained therein into SAP configuration objects or configuration tables as the final configuration settings 146 for the instantiated enterprise payroll system 102. The configuration commander tool is described in more detail below in regard to FIG. 7.

According to some embodiments, steps 506 and 508 of the routine 500 may be repeated iteratively in order to further configure the instantiated enterprise payroll system 102 based on additional configuration input 310 from the user 312. The configuration assistant application 308 may further be used iteratively to correct any errors and reconfigure the instantiated enterprise payroll system 102, as shown at step 510. Once the final configuration settings 146 are complete and loaded into the instantiated enterprise payroll system 102, the routine 500 ends.

FIG. 6 illustrates one routine 600 for generating the generated configuration set 306 based on the configuration input 310 from the user 312, according to some embodiments. The routine 600 may be utilized during step 506 of routine 500 described above, for example. According to some embodiments, the routine 600 may be performed by the configuration assistant application 308 described above in regard to FIG. 3 executing on the server computer(s) 202C. The routine 600 begins at step 602, where the configuration assistant application 308 accesses configuration rules defined in the pre-configured database of configuration logic 316 corresponding to the pre-configured payroll template 302 utilized in step 504 to generate a set of strategic questions for the user 312. For example, in the case of an SAP BUSINESS SUITE payroll system installation, the configuration assistant application 308 may read SAP configuration options from the pre-configured database of configuration logic 316 and combine these with actual SAP configuration settings 146 from the pre-configured standard payroll system to generate a sequence of questions in business language, the answers to which allow the configuration assistant application to determine the appropriate implementation-specific configuration parameters and values for the instantiated enterprise payroll system 102.

From step 602, the routine 600 proceeds to step 604, where the configuration assistant application 308 leads the user 312 through the generated questions and collect the configuration input 310 from the user, as described above in regard to FIG. 3. For example, the configuration assistant application 308 may display the generated questions to the user 312 through a user interface 400 on a client computing device 314. The user 312 may then utilize the user interface 400 to provide the configuration input 310 in the form of answers to the displayed questions.

The routine 600 then proceeds from step 604 to step 606, where the configuration assistant application 308 uses the provided configuration input 310 to generate the generated configuration set 306 containing the appropriate implementation-specific configuration settings. For example, the configuration assistant application 308 may utilize the answers to these questions provided by the user 312 and applicable business rules from the pre-configured database of configuration logic 316 to generate the generated configuration set 306 containing the configuration values for the payroll system parameters and options that reflect the user's specific requirements. The configuration assistant application 308 may write the generated configuration set 306 to a file in a format that can be utilized by the configuration loader 318 to upload the configuration values into the instantiated enterprise payroll system 102, as described above in regard to step 508 of routine 500. The file may be stored on any suitable data storage device or devices accessible to the configuration loader 318. From step 606, the routine 600 ends.

FIG. 7 shows further aspects of the configuration commander tool 700 that may be utilized to perform the functions of the configuration loader 318 as well as other components or steps described herein for rapidly implementing and deploying enterprise payroll. Effective configuration management may be a crucial aspect of the payroll system implementation process, from design to testing and deployment. Configuration may be managed across multiple environments, and various teams may need to understand aspects of the latest configuration settings. The configuration commander tool 700 may support and enable the implementation and support teams to efficiently and accurately perform these functions.

According to some embodiments, the configuration commander tool 700 may include snapshot functionality 702 that allows users to take a snapshot of the configuration settings 146 from the instantiated enterprise payroll system 102 and store them in one or more data files 704A-704N (also referred to herein generally as data files 704). The data files 704 may represent XML files, spreadsheet files, CSV files or any other files in any format known in the art. The data files 704 may be utilized in a number of ways. For example, the snapshot functionality 702 may be utilized to compare current configuration settings 146 with a previously saved snapshot data files 704N to provide information on what has changed in the configuration settings. This may allow users to perform multi-way comparisons of enterprise payroll environments in real-time, thereby pinpointing differences introduced by upgrades, support packs, projects and on-going system maintenance.

In addition, the snapshot data files 704 may provide the user with configuration information, such as a list of all wage types or a list of work schedules with detailed shift pattern information, that can be used for communication with other business users. This may also provide an effective means to monitor and validate configuration settings 146 in a distributed project environment where projects teams may be working on multi-site implementations. The snapshot functionality 702 may further provide a means to extract configuration settings 146 to incorporate into the pre-configured database of configuration logic 316, as described above in regard to FIG. 3.

The configuration commander tool 700 may also support information gathering from business users for areas where many configuration settings 146 are required. A snapshot data file 704 of the current configuration settings 146 can be generated and users, such as users 706, may modify these settings by adding, changing and deleting entries. The resulting modified data file 704A may then be uploaded by upload functionality 708 of the configuration commander tool 700 back to the configuration settings 146 of the instantiated enterprise payroll system 102. The upload functionality 708 may utilize the normal configuration table maintenance transactions of the enterprise payroll application 142 and appropriate messages and warning may be generated to inform the user of any possible overwrites in the upload process. According to further embodiments, the upload functionality 708 of the configuration commander tool 700 may be employed to upload the generated configuration set 306 into the instantiated enterprise payroll system 102, as described above in regard to step 508 of routine 500.

The configuration commander tool 700 may be implemented in a generic fashion in order to support a variety of enterprise payroll applications 142 and other system formats. The configuration commander tool 700 may further provide customization through the implementation of specific “override classes.” The override classes may provide special views that combine information from several configuration tables in the instantiated enterprise payroll system 102 or that simplify the information extracted. The override classes may further provide for special formatting to facilitate the presentation of complicated configuration settings 146. Special views can also be built for configuration areas that are transaction driven and not directly dependent on table maintenance views.

It will be appreciated that, while some embodiments described herein refer to SAP BUSINESS SUITE payroll installations or the relevant components of such installations, the systems, methods, tools and components described herein are not limited to the SAP BUSINESS SUITE application and may be applied to any enterprise payroll system. Furthermore, the systems, methods, tools and components described herein may be fully adaptable for use in enterprise software systems beyond the enterprise payroll systems described herein.

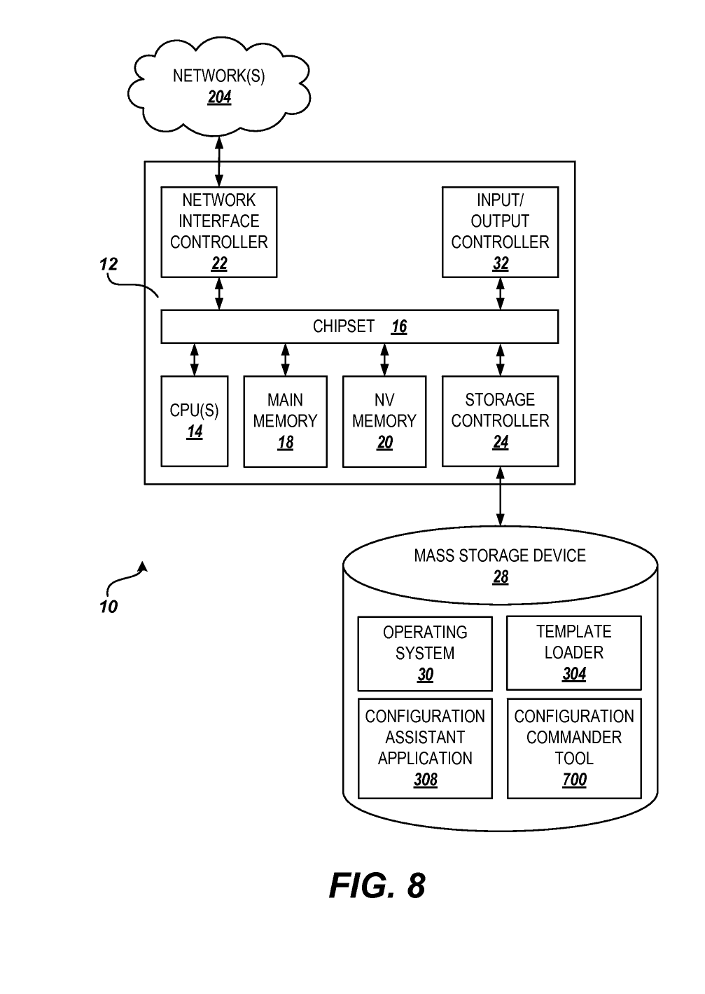

FIG. 8 shows an example computer architecture 10 for a computer 12 capable of executing the software components described herein for rapidly implementing and deploying enterprise payroll systems, in the manner presented above. The computer architecture 10 shown in FIG. 8 illustrates a conventional server computer, workstation, desktop computer, laptop, PDA, electronic book reader, digital wireless phone, network appliance, set-top box or other computing device, and may be utilized to execute any aspects of the software components presented herein described as executing on the server computers(s) 202A-202C, client computing devices 314 or other computing platforms.

The computer 12 includes a baseboard, or “motherboard,” which is a printed circuit board to which a multitude of components or devices may be connected by way of a system bus or other electrical communication paths. In one illustrative embodiment, one or more central processing units (“CPUs”) 14 operate in conjunction with a chipset 16. The CPUs 14 may represent standard programmable processors that perform arithmetic and logical operations necessary for the operation of the computer 12.

The CPUs 14 perform the necessary operations by transitioning from one discrete, physical state to the next through the manipulation of switching elements that differentiate between and change these states. Switching elements may generally include electronic circuits that maintain one of two binary states, such as flip-flops and electronic circuits that provide an output state based on the logical combination of the states of one or more other switching elements, such as logic gates. These basic switching elements may be combined to create more complex logic circuits, including registers, adders-subtractors, arithmetic logic units, floating-point units or the like.

The chipset 16 provides an interface between the CPUs 14 and the remainder of the components and devices on the baseboard. The chipset 16 may provide an interface to a main memory 18 of the computer 12, such as a random access memory (“RAM”). The chipset 16 may further provide an interface to a non-volatile memory 20, such as a read-only memory (“ROM”) or non-volatile RAM (“NVRAM”), for storing basic routines that help to startup the computer 12 and to transfer information between the various components and devices. The main memory 18 and/or non-volatile memory 20 may also store software components necessary for the operation of the computer 12 in accordance with the embodiments described herein.

According to various embodiments, the computer 12 may operate in a networked environment using logical connections to remote computing devices and computer systems through one or more networks, such as a local-area network (“LAN”), a wide-area network (“WAN”), the Internet or any other networking topology known in the art that connects the computer 12 to remote computers. The chipset 16 may include functionality for providing network connectivity through a network interface controller (“NIC”) 22, such as a gigabit Ethernet adapter. For example, the NIC 22 may be capable of connecting the computer 12 to other computers or systems over the network(s) 204, such as the server computers 202A-202C or the client computing devices 314 described above in regard to FIGS. 2 and 3. It should be appreciated that any number of NICs 22 may be present in the computer 12, connecting the computer to other types of networks and remote computer systems.

The computer 12 may be connected to a mass storage device 28 that provides non-volatile storage for the computer. The mass storage device 28 may store system programs, application programs, other program modules and data, which are described in greater detail herein. The mass storage device 28 may be connected to the computer 12 through a storage controller 24 connected to the chipset 16. The mass storage device 28 may consist of one or more physical storage units. The storage controller 24 may interface with the physical storage units through a serial attached SCSI (“SAS”) interface, a serial advanced technology attachment (“SATA”) interface, a fiber channel (“FC”) interface or other standard interface for physically connecting and transferring data between computers and physical storage devices.

The computer 12 may store data on the mass storage device 28 by transforming the physical state of the physical storage units to reflect the information being stored. The specific transformation of physical state may depend on various factors, in different implementations of this description. Examples of such factors may include, but are not limited to, the technology used to implement the physical storage units, whether the mass storage device 28 is characterized as primary or secondary storage or the like. For example, the computer 12 may store information to the mass storage device 28 by issuing instructions through the storage controller 24 to alter the magnetic characteristics of a particular location within a magnetic disk drive unit, the reflective or refractive characteristics of a particular location in an optical storage unit, or the electrical characteristics of a particular capacitor, transistor or other discrete component in a solid-state storage unit. Other transformations of physical media are possible without departing from the scope and spirit of the present description, with the foregoing examples provided only to facilitate this description. The computer 12 may further read information from the mass storage device 28 by detecting the physical states or characteristics of one or more particular locations within the physical storage units.

In addition to the mass storage device 28 described above, the computer 12 may have access to other computer-readable medium to store and retrieve information, such as program modules, data structures or other data. It should be appreciated by those skilled in the art that computer-readable media can be any available media that may be accessed by the computer 12, including computer-readable storage media and communications media. Communications media includes transitory signals. Computer-readable storage media includes volatile and non-volatile, removable and non-removable storage media implemented in any method or technology for the non-transitory storage of information. For example, computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY or other optical storage, magnetic cassettes, magnetic tape, magnetic disk storage or other magnetic storage devices and the like.

The mass storage device 28 may store an operating system 30 utilized to control the operation of the computer 12. According to one embodiment, the operating system 30 comprises the LINUX operating system. According to another embodiment, the operating system comprises the WINDOWS° SERVER operating system from MICROSOFT Corporation of Redmond, Wash. According to further embodiments, the operating system may comprise the UNIX or SOLARIS operating systems. It should be appreciated that other operating systems may also be utilized.

The mass storage device 28 may store other system or application programs and data utilized by the computer 12, such as the template loader 304, the configuration assistant application 308 and the configuration commander tool 700, each of which was described above in regard to FIGS. 3 and 7. In one embodiment, the mass storage device 28 or other computer-readable storage media may be encoded with computer-executable instructions that, when loaded into the computer 12, may transform the computer from a general-purpose computing system into a special-purpose computer capable of implementing the embodiments described herein. These computer-executable instructions transform the computer 12 by specifying how the CPUs 14 transition between states, as described above. According some embodiments, the computer 12 may have access to computer-readable storage media storing computer-executable instructions that, when executed by the computer, perform the routines 500 and 600 described herein for rapidly implementing and deploying enterprise payroll systems, as described above in regard to FIGS. 5 and 6.

The computer 12 may also include an input/output controller 32 for receiving and processing input from a number of input devices, such as a keyboard, a mouse, a touchpad, a touch screen, an electronic stylus or other type of input device. Similarly, the input/output controller 32 may provide output to a display device, such as a computer monitor, a flat-panel display, a digital projector, a printer, a plotter or other type of output device. It will be appreciated that the computer 12 may not include all of the components shown in FIG. 8, may include other components that are not explicitly shown in FIG. 8, or may utilize an architecture completely different than that shown in FIG. 8.

Based on the foregoing, it will be appreciated that technologies for rapidly implementing and deploying enterprise payroll systems are presented herein. The above-described embodiments are merely possible examples of implementations, set forth for a clear understanding of the principles of the present disclosure. The logical operations, functions or steps described herein as part of a method, process or routine may be implemented (1) as a sequence of processor-implemented acts, software modules or portions of code running on a computer or computing system and/or (2) as interconnected machine logic circuits or circuit modules within the computer or computing system. The implementation is a matter of choice dependent on the performance and other requirements of the system. Alternate implementations are included in which operations, functions or steps may not be included or executed at all, may be executed out of order from that shown or discussed, including substantially concurrently or in reverse order, depending on the functionality involved, as would be understood by those reasonably skilled in the art of the present disclosure.

It will be further appreciated that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

Many variations and modifications may be made to the above-described embodiments without departing substantially from the spirit and principles of the present disclosure. Further, the scope of the present disclosure is intended to cover any and all combinations and sub-combinations of all elements, features and aspects discussed above. All such modifications and variations are intended to be included herein within the scope of the present disclosure, and all possible claims to individual aspects or combinations of elements or steps are intended to be supported by the present disclosure.

What is claimed is:

1. A method comprising steps of:
loading, by a first server computer, a pre-configured payroll template into a standard enterprise payroll system to form a pre-configured standard payroll system, the standard enterprise payroll system deployed on one or more server computers;
generating, by a second server computer, a configuration set comprising implementation-specific configuration values; and
creating, by a third server computer, an instantiated enterprise payroll system by loading the generated configuration set into the pre-configured standard payroll system.

2. The method of claim 1, wherein the pre-configured payroll template comprises a plurality of patterns, each of the plurality of patterns representing a valid set of payroll application configuration objects in the standard enterprise payroll system.

3. The method of claim 1, wherein generating the configuration set comprises:
accessing, by the second server computer, a pre-configured database comprising business rule configuration logic for managing at least one implementation-specific configuration value;
generating, by the second server computer, a set of questions based on the business rule configuration logic;
presenting, by the second server computer, the set of questions to a user;
collecting, by the second server computer, configuration input from the user, the configuration input comprising answers to the set of questions; and
generating, by the second server computer, the configuration set based on the collected configuration input and the business rule configuration logic.

4. The method of claim 3, wherein the pre-configured database corresponds to the pre-configured payroll template.

5. The method of claim 1, wherein generating the configuration set and loading the generated configuration set are repeated iteratively until final configuration settings are loaded in the instantiated enterprise payroll system.

6. The method of claim 1, wherein the instantiated enterprise payroll system comprises an enterprise payroll application, a payroll template and configuration settings.

7. The method of claim 1, wherein the configuration set is generated by an application executing on the second server computer.

8. The method of claim 1, wherein the generated configuration set comprises a spreadsheet file.

9. The method of claim 1 wherein two or more of the first server computer, the second server computer and the third server computer comprise a same server computer.

10. A computer-readable storage medium having processor-executable instructions stored thereon that, when executed by a processor, cause the processor to:
access a pre-configured database comprising business rule configuration logic for managing at least one implementation-specific configuration value of an enterprise payroll system;
generate a set of business-language questions based on the business rule configuration logic;
present the set of questions to a user through a user interface;
collect configuration input comprising answers to the set of questions from the user; and
generate a configuration set based on the collected configuration input and the business rule configuration logic, the configuration set configured to be loaded into a pre-configured standard payroll system to create an instantiated enterprise payroll system.

11. The computer-readable storage medium of claim 10, wherein the pre-configured standard payroll system is created by deploying a standard enterprise payroll system and loading a pre-configured payroll template into the standard enterprise payroll system.

12. The computer-readable storage medium of claim 11, wherein the pre-configured payroll template comprises a plurality of patterns, each of the plurality of patterns representing a valid set of payroll application configuration objects in the standard enterprise payroll system.

13. The computer-readable storage medium of claim 11, wherein the pre-configured database is associated with a particular country in which the instantiated enterprise payroll system is implemented.

14. The computer-readable storage medium of claim 11, wherein the pre-configured database corresponds to the pre-configured payroll template.

15. The computer-readable storage medium of claim 10, wherein the instantiated enterprise payroll system comprises an enterprise payroll application, a payroll template and configuration settings.

16. The computer-readable storage medium of claim 15, wherein the enterprise payroll system comprises the SAP BUSINESS SUITE payroll application.

17. A system for implementing an enterprise payroll system, comprising:
a memory;
a processor operably connected to the memory; and
a configuration assistant application residing in the memory and configured to cause the processor to:
access a pre-configured database comprising business rule configuration logic for managing at least one implementation-specific configuration value of an enterprise payroll system;
generate a set of business-language questions based on the business rule configuration logic;
present the set of questions to a user through a user interface;
collect configuration input comprising answers to the set of questions from the user; and
generate a configuration set based on the collected configuration input and the business rule configuration logic, the configuration set configured to be loaded into a pre-configured standard payroll system to create an instantiated enterprise payroll system.

18. The system of claim 17, wherein the pre-configured standard payroll system is created by deploying a standard enterprise payroll system and loading a pre-configured payroll template into the standard enterprise payroll system, the pre-configured payroll template comprising a plurality of patterns, each of the plurality of patterns representing a valid set of payroll application configuration objects in the standard enterprise payroll system.

19. The system of claim 18, wherein the pre-configured database corresponds to the pre-configured payroll template.

20. The system of claim 17, wherein the instantiated enterprise payroll system comprises an enterprise payroll application, a payroll template and configuration settings.
